(19) United States
(12) Patent Application Publication
(10) Pub. No.: US 2026/0273445 A1
(43) Pub. Date: Sep. 17, 2026

(54) COALESCING SEPARATOR INSERT, COALESCING SEPARATOR, AND PROCESS FOR MANUFACTURING A COALESCING SEPARATOR INSERT

(71) Applicant: MANN+HUMMEL GmbH, Ludwigsburg (DE)

(72) Inventors: Thomas GREIN, Eggenstein-Leopoldshafen (DE); Frank VOGT, Hanhofen (DE)

(21) Appl. No.: 19/466,642

(22) Filed: Feb. 2, 2026

Related U.S. Application Data
(63) Continuation of application No. PCT/EP2024/071255, filed on Jul. 26, 2024.

(30) Foreign Application Priority Data
Aug. 11, 2023 (DE) 10 2023 121 509.4

(51) Int. Cl. B01D 46/00; B01D 46/24; B01D 46/64

(52) U.S. Cl. CPC B01D 46/003; B01D 46/0001; B01D 46/2403; B01D 46/64; B01D 2279/30

(57) ABSTRACT

A coalescing separator insert for separating liquid from a gas flow includes a first coalescing separator body made of a first coalescing separator medium arranged around an air-permeable support tube supporting the first coalescing separator body. A second coalescing separator body made of a second coalescing separator medium is arranged in a gas flow direction downstream of the first coalescing separator body concentric to the first coalescing separator body and is wound at least in sections into a multi-layer winding. The second coalescing separator body has at least in sections at least two layers of the second coalescing separator medium arranged overlappingly relative to each other in the gas flow direction and connected to each other at least in sections for fixation of the multi-layer winding. A coalescing separator is provided with the coalescing separator insert and a method of manufacturing the coalescing separator insert is provided.

### CROSS-REFERENCE TO RELATED APPLICATIONS

This application is a continuation application of international application No. PCT/EP2024/071255 having an international filing date of Jul. 26, 2024, and designating the United States, the international application claiming a priority date of Aug. 11, 2023, based on prior filed German patent application No. 10 2023 121 509.4, the entire contents of the aforesaid applications being incorporated herein by reference to the fullest extent permissible.

### BACKGROUND

The invention concerns a coalescing separator insert, for example an air oil separator element, for separating liquid, for example liquid drops, for example, oil, for example oil drops, from a gas flow, for example from an air flow, for example, from a compressed air flow, wherein the gas flow in the position of use of the coalescing separator insert flows through the coalescing separator insert from the exterior to the interior or from the interior to the exterior, the coalescing separator insert including: at least one first coalescing separator body including at least one first coalescing separator medium, which is configured to separate liquid from the gas flow by means of the coalescence principle and which is arranged around an air-permeable, cylindrical first support tube configured to support the first coalescing separator body, and at least one further coalescing separator body including at least one further coalescing separator medium, which is configured to separate liquid from the gas flow by means of the coalescence principle and is arranged in flow direction of the gas flow downstream of the first coalescing separator body and is arranged concentrically to the first coalescing separator body, for example, is wound around a further support tube configured to support the further coalescing separator body.

The invention concerns furthermore a coalescing separator including a coalescing separator insert as described above and a pressure-stable housing for receiving the coalescing separator insert.

The invention concerns furthermore a process of manufacturing a coalescing separator insert for cleaning a gas flow which, in the position of use of the coalescing separator insert, flows through the coalescing separator insert from the exterior to the interior or from the interior to the exterior, wherein:
(I) for providing a first coalescing separator body, at least one first coalescing separator medium, configured to separate liquid by means of the coalescence principle, for example liquid drops, for example, oil, for example, oil drops, from a gas flow, for example from an air flow, for example, from a compressed air flow, is arranged around a cylindrical air-permeable first support tube configured to support the first coalescing separator medium; and
(ii) for providing a further coalescing separator body, at least one further coalescing separator medium, configured to separate liquid from the gas flow by means of the coalescence principle, is arranged concentrically to the first coalescing separator body, for example, is arranged around a cylindrical air-permeable further support tube configured to support the further coalescing separator medium.

Air oil separator elements are known from the printed publication EP 1 738 816 B1, for example. The air to be purified flows from the exterior to the interior or from the interior to the exterior through the air oil separator element, wherein a multi-layer main separator acting in accordance with the coalescence principle separates and coalesces oil drops from the air flowing through. The secondary aerosol exiting from the main separator flows subsequently through a further coalescing separator body, a post separator, wherein the enlarged coalesced drops are separated and drained following the force of gravity.

For manufacturing the post separator, usually heavy nonwovens, for example, staple fiber nonwovens, for example carded materials, are used. As shown in the drawing figures of EP 1 738 816 B1, the post separator is embodied as a single layer. The nonwoven layer of the post separator embodied as a single layer is formed by sewing or fusing to a hose in a conventional manner and subsequently being pulled over the support tube.

It is the object of the invention to further develop a coalescing separator insert of the aforementioned kind, a coalescing separator of the aforementioned kind, and a process of the aforementioned kind in such a way that the coalescing separator insert may be manufactured particularly easily, inexpensively, and with a high variant variety, while still achieving a high degree of separation. For example, the post separator is to be manufacturable from simple or inexpensive coalescing separator medium material.

### SUMMARY

This object is solved by a coalescing separator insert of the aforementioned kind wherein:
the further coalescing separator medium is wound at least in sections in multiple layers, for example, is wound at least in sections in multiple layers around the further support tube, and the further coalescing separator body includes at least in sections at least two coalescing separator medium layers arranged overlappingly relative to each other in flow direction of the gas flow, and
the coalescing separator medium layers arranged overlappingly relative to each other are connected to each other at least in sections for fixation of the winding of the further coalescing separator body.

This object is further solved by a coalescing separator of the aforementioned kind and includes a coalescing separator insert in accordance with the invention, wherein the pressure-stable housing includes a cup-shaped housing body, a cover configured to close the open end face of the housing body, a raw gas inlet configured to supply raw gas to the coalescing separator and connectable to a raw gas feed of a connector element of a machine, and a clean gas outlet configured to discharge clean gas and connectable to a clean gas discharger of the connector element.

This object is further solved by a method of the aforementioned kind, wherein, in arranging the further coalescing separator body as described in process step (ii) above, the further coalescing separator medium is wound such that the further coalescing separator body is embodied at least in sections of multiple layers and includes at least two coalescing separator medium layers arranged overlappingly relative to each other in a flow direction of the gas flow to be purified, and, for stabilizing the winding of the further coalescing separator body, for example, arranged at the further support tube, at least regions of the coalescing separator medium layers arranged overlappingly relative to each other are connected to each other.

Exemplary embodiments and expedient further developments of the present invention are further described in the following detailed description and illustrated in the accompanying drawing figures.

Thus, the present invention is based on the further coalescing separator medium of the further coalescing separator body, embodied for example as a post separator, at least in sections
being wound in multiple layers, for example, being wound in multiple layers around the further support tube, and
including at least two coalescing separator medium layers arranged overlappingly relative to each other in a flow direction of the gas flow.

This multi-layer feature makes it possible to adapt the further coalescing separator body in a simple manner to various demands of the coalescing separator insert.

The further support tube is optional. In principle, the structure of the multi-layer coalescing separator body may function also without an additional or further support tube. The further support tube is a cylindrical hollow body which, for example, may be manufactured from metal, from plastic material, or from fabric.

For fixation of the winding of the further coalescing separator body, the coalescing separator medium layers arranged overlappingly relative to each other are connected to each other at least in sections. For example, at least the radially outer overlappingly arranged coalescing separator medium layers of the further coalescing separator body include fixation regions connected to each other and embodied for fixation of the winding.

The overlapping arrangement or the overlap amounts to at least one sixteenth of a full turn winding, for example, one eighth of a full turn winding, for example at least one fourth of a full turn winding, of the winding of the outer coalescing separator medium layer of the further coalescing separator body.

An inexpensive possibility for manufacturing the further coalescing separator body of the coalescing separator insert according to the invention resides in winding a web of the further coalescing separator medium with subsequent fixation of overlappingly arranged coalescing separator medium layers of the further coalescing separator body. The fixation may be realized, for example, by means of joining and/or gluing and/or sewing. A fixation by means of the technique of joining, for example of fusing, may be manufactured efficiently.

The coalescing separator medium layers overlappingly arranged relative to each other are thus connected to each other with the aid of fixation regions provided by means of a joining technique, for example by means of the technique of fusing and/or of gluing and/or of sewing.

In comparison to the prior manufacture of a post separator in which the latter is formed to a hose, fixed, and subsequently pulled over the further support tube, the manufacture of the further coalescing separator body according to the present invention, in which the further coalescing separator medium is wound, for example, onto the further support tube, and overlapping regions are fixed relative to each other at least in sections, is a significantly less expensive type of manufacture.

In addition, the further coalescing separator body manufactured according to the present invention may be adapted in a simple manner to different demands in regard to separation.

An embodiment of the present invention includes, for example, a further coalescing separator body wound substantially as one layer, wherein however at least one region of the further coalescing separator body is embodied of two layers and includes overlapping coalescing separator medium layers which at least in sections are connected to each other or fixed at each other.

In a further embodiment of the present invention, the entire further coalescing separator body is constructed of multiple layers. For example, the post separator may be formed of a multi-layer drainage material. This multi-layer winding enables a simple adaptation of the post separator to different dimension demands and/or separation demands.

An advantage of the present invention is thus that the number of layers of the further coalescing separator body may be selected depending on the demand in regard to its degree of separation. This makes it possible to manufacture different separator variants with the same coalescing separator material. In contrast thereto, in case of single-layer post separators known from the prior art, a specific individually adapted coalescing separator material with a defined material thickness must be manufactured, respectively, for manufacturing different separator variants.

Due to the overlap of the layers of the further coalescing separator body in accordance with the invention, there is additionally the possibility provided of connecting the overlapping coalescing separator medium layers of the further coalescing separator body only locally to each other. For example, the fixation regions may be spaced apart from each other in the direction of the longitudinal axis of the further coalescing separator body and separated from each other by unconnected regions of the further coalescing separator body.

The respective layers of the post separator may thus be attached to each other by means of at least two fixation regions, for example. In the prior art, on the other hand, the single-layer post separator medium is connected by means of a continuous connecting seam to a hose. In the present invention, it has been surprisingly found that even a seam that is not continuous, i.e., interrupted, connects sufficiently seal-tightly the layers of the further coalescing separator body to each other so that the coalescing separator performance may be maintained unimpaired.

The application of an interrupted seam with locally spaced apart fixation regions is advantageous when manually manufacturing the coalescing separator insert. For manufacturing a continuous seam, the coalescing separator insert would have to be clamped into a device and aligned in order to position the seam in a straight line in the desired region. Local fixation regions, on the other hand, may be manually applied without clamping and aligning the coalescing separator insert. This results in the advantage that the post separator may be manufactured more efficiently.

In addition, the application of local fixation regions in the manual manufacture is significantly faster than realizing a continuous seam. In this manner, the manual manufacture of the coalescing separator insert may thus be significantly facilitated.

In an embodiment of the present invention, for example, a coalescing separator medium material, known from post separators, may be wound in two layers, for example, wound in two layers around the further support tube. This is advantageous primarily when increased demands are made in regard to the degree of separation of the post separator.

Furthermore, a multi-layer construction of the post separator enables its manufacture from coalescing separator media, for example, from nonwovens, which, in comparison to the known single-layer post separator media are formed more lightweight and are offered in larger quantities as well as inexpensively for standard applications. For example, the further coalescing separator body may be formed from at least one coalescing separator medium, for example, a nonwoven, which in the form of a single (endless) flat web has a grammage of up to 300 grams per square meter (g/m5), for example, of 25 to 250 g/m5 , for example of 50 to 200 g/m5.

As a material for the further coalescing separator medium, for example, staple fiber nonwoven and/or spunbond nonwoven and/or meltblown nonwoven may be used. Spunbond nonwovens are usually thin. The multi-layer construction enables the formation of thicker layers. Staple fiber nonwovens provide relatively thick inexpensive layers, even in case of a few layers.

Furthermore, the material of the further coalescing separator medium may include, at least mainly, polyester fibers, polyamide fibers or glass fibers or mixtures thereof.

The radial thickness of the further coalescing separator body (see, FIG. 4 at D20) is less than the radial thickness of the first coalescing separator body.

A thickness of all coalescing separator medium layers of the further coalescing separator body of an embodiment of the present invention, for example, determined according to DIN EN ISO 9073-2, i.e., at a contact pressure of 0.5 kPa, amounts to a total of more than two millimeters (mm), for example more than 2.5 mm, for example, 4 mm to 10 mm.

In another embodiment, the further coalescing separator body is designed such that an air permeability through the further coalescing separator body, for example, determined according to DIN EN ISO 9237, amounts to more than 300 liters per square meter second [l/m2s] and less than 4,500 liters per square meter second [l/m2s] at a pressure differential of 200 Pascal [Pa].

In comparison thereto, the air permeability of the first coalescing separator body, for example of the main separator, amounts to less than 400l/m2 s, for example, 5-300 l/m2s.

In connection therewith or as an alternative thereto, in an embodiment of the present invention the first coalescing separator body may be arranged, for example wound, in multiple layers around the first support tube. The main separator may be included, for example, of a plurality of, for example, 3 to 20, coalescing separator medium layers, for example, glass fiber paper layers.

The further coalescing separator body is designed such that it includes a higher gas flow permeability, for example air permeability, than the respective layers of the first coalescing separator body. For example, a single layer of the main separator may include a reduced permeability in comparison to the entire post separator, for example, half of the permeability of the post separator.

The present invention provides a coalescing separator insert as well as a coalescing separator with a post separator optimized with respect to separation, drainage, and manufacture.

Finally, the present invention concerns the use of at least one coalescing separator insert of the previously described type and/or of a coalescing separator insert manufactured according to the method of the previously described type and/or of a coalescing separator configured according to the previously described type
for air oil separation of air in a compressed air system or vacuum system that is supplied, for example, by an oil-lubricated connector element of a machine, for example, of a compressor or of a vacuum pump, wherein the compressed air system is furthermore configured to return the separated oil to the connector element, or
for air oil separation of the crankcase gases of an internal combustion engine or of a piston compressor.

For example, the coalescing separator insert of the present invention may be used in the following applications:
in a spin-on coalescing separator or spin-on air oil separator,
in a compressor configured to compress air,
in a compressor configured for separation of oil, wherein the separated oil is returned to the oil circuit, and
in applications with oils of the viscosity class VG32 and higher viscosity.

### BRIEF DESCRIPTION OF THE DRAWINGS

As already mentioned above, there are various possibilities to design and further develop the teachings of the present invention in an advantageous manner. In this regard, further configurations, features, and advantages of the present invention will be explained in the following detailed description with the aid of the exemplary embodiments illustrated in the accompanying drawing figures.

FIG. 1 shows in schematic illustration a first embodiment of a coalescing separator according to the present invention, wherein a coalescing separator insert is manufactured according to the method of the present invention.

FIG. 2 shows in schematic illustration a second embodiment of a coalescing separator according to the present invention, wherein a coalescing separator insert is manufactured according to the method of the present invention.

FIG. 3 shows in perspective illustration the further coalescing separator body of the coalescing separator insert of FIG. 1 or of the coalescing separator insert of FIG. 2.

FIG. 4 shows a cross section of the further coalescing separator body of FIG. 3 in which the various coalescing separator medium layers are visible.

FIG. 5 shows a view from the front of the further coalescing separator body of FIG. 3.

FIG. 6 shows a side view of the further coalescing separator body of FIG. 3.

FIG. 7 shows a further embodiment of a coalescing separator insert manufactured according to the method of the present invention.

FIG. 8 shows the coalescing separator insert of FIG. 7 in longitudinal section illustration.

Same or similar configurations, elements or features are identified in the drawing figures with like reference characters.

### DETAILED DESCRIPTION

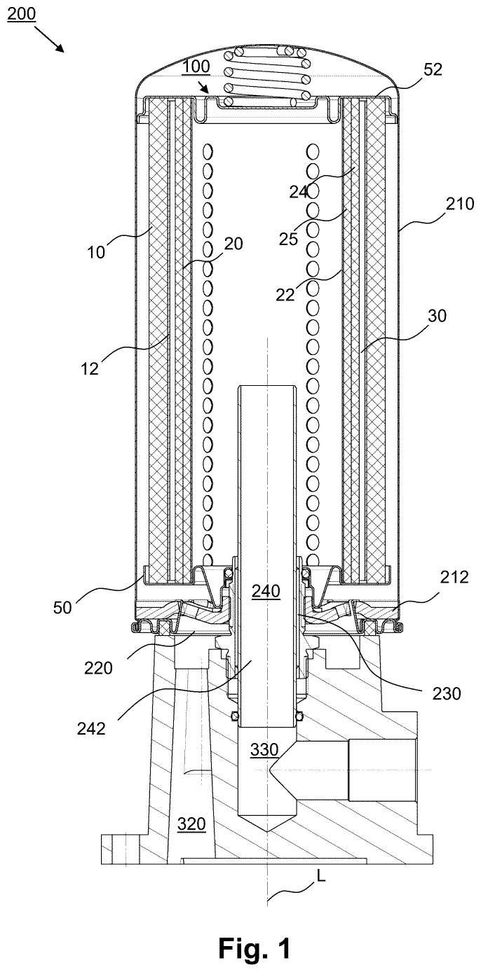

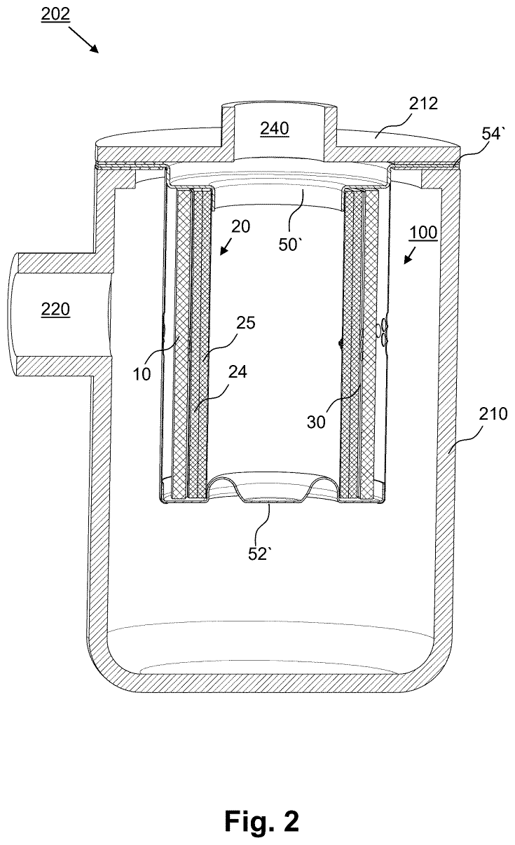

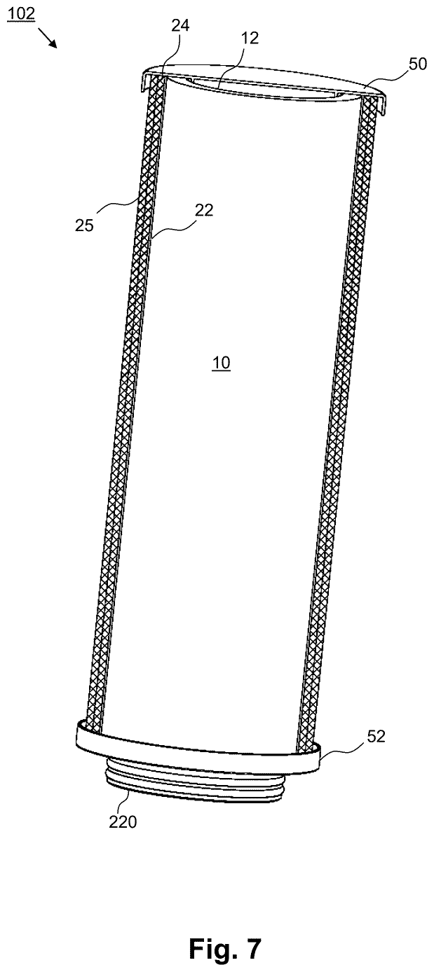

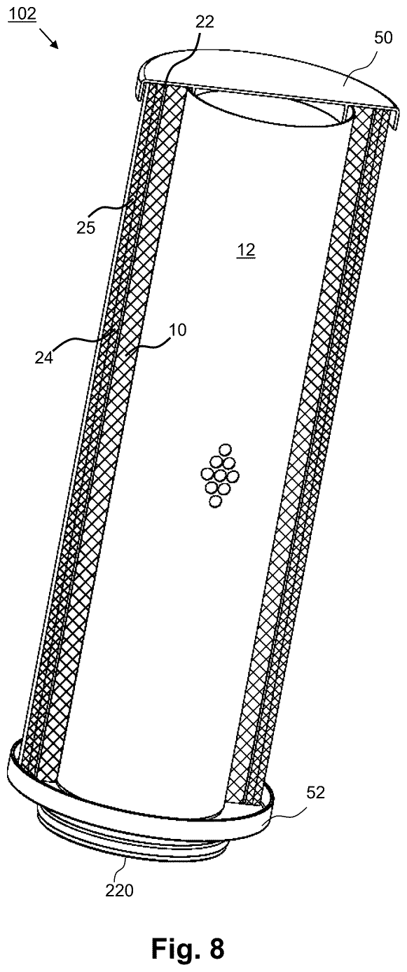

For avoiding unnecessary repetitions, the following explanations in regard to configurations, features, and advantages of the present invention relate (if nothing else is mentioned) to the first embodiment of a coalescing separator 200 illustrated in FIG. 1, comprising a first embodiment of a coalescing separator insert 100 according to the present invention, as well as to the second embodiment of a coalescing separator 202 according to the present invention illustrated in FIG. 2, as well as to the further embodiment of a coalescing separator insert 102 according to the present invention illustrated in FIGS. 7 and 8.

FIG. 1 shows a longitudinal section of a coalescing separator, namely a so-called spin-on air oil separator 200. Separator 200 is embodied for separating particles from a gas or from a gas mixture, for example for separating an aerosol, formed of liquid, from air. The liquid to be separated may be, for example, oil, fuel, hydraulic liquid or coolant.

The coalescing separator 200 comprises a cup-shaped pressure-stable housing body 210 in which an embodiment of a coalescing separator insert 100 configured according to the present invention is received.

A cover 212 serves for closing the open end face of the housing body 210. For supplying raw gas, the coalescing separator 200 comprises a raw gas inlet 220 which is connectable to a raw gas feed of a connector element 320 of a machine, for example, of a work machine, for example of a compressor, for example, of a compressed air compressor, for example, a screw compressor. For discharging the purified clean gas, the coalescing separator 200 comprises a clean gas outlet 240 which is connectable to a clean gas discharger of the connector element 330.

In the spin-on air oil separator 200 illustrated in FIG. 1, the raw gas inlet 220 as well the clean gas outlet 240 are arranged at the cover 212, wherein the clean gas outlet 240 comprises a central cylinder-shaped cutout in which. for example a tube-shaped nipple 242 may be arranged which axially extends through the cover 212. The nipple 242 is correlated with the connector element.

Furthermore, the cover 212 illustrated in FIG. 1 comprises at least one closure element that is movable by a rotational movement of the cover 212 between an open position, in which the nipple 242 may be guided along a central axis L of the cup-shaped housing body 210 through the cover 212, and a closed position in which the nipple 242 is fixedly connected to the cover 212.

The hollow cylindrically embodied coalescing separator insert 100 illustrated in FIGS. 1 and 2 comprises at its respective end face an end disk 50, 50′, 52, 52′ for covering the respective end face.

In FIG. 2, the coalescing separator insert is illustrated in a cup-shaped housing body, namely a compressed air pot 210. It differs from the spin-on air oil separator 200 for example in that the raw gas inlet 220 is arranged at the compressed air pot 210, the clean gas outlet 240 is arranged at the cover 212, and the end disk 50′ facing the cover 212 comprises a radially extending flange 54′ which is configured to arrange the coalescing separator insert 100 in the pressure-stable housing 210.

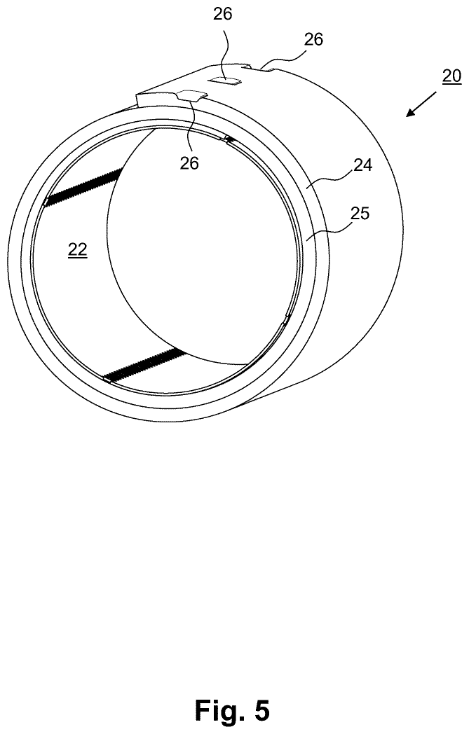

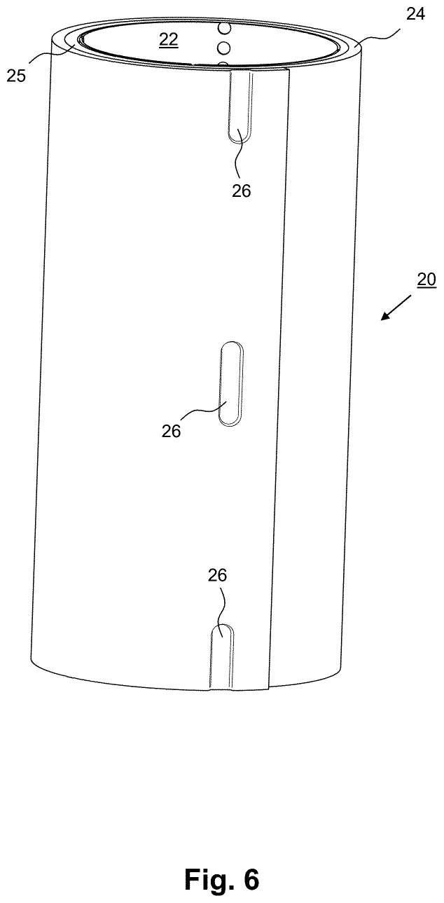

The coalescing separator insert 100 illustrated in FIGS. 1 to 6 serves for purifying air which flows therethrough from the exterior to the interior. The coalescing separating insert 102 illustrated in FIGS. 7 and 8 is flowed through from the interior to the exterior.

In this context, the designation toward the exterior refers to a direction which is arranged perpendicularly to the longitudinal axis L of the coalescing separator insert and, beginning at the longitudinal axis L of the coalescing separator insert, is oriented radially outwardly, i.e., toward the outer circumference of the coalescing separator insert. The designation toward the interior, on the other hand, refers to a direction which is arranged perpendicularly to the longitudinal axis L of the coalescing separator insert and, beginning at the outer circumference of the coalescing separator insert, is oriented radially inwardly, i.e., toward the longitudinal axis L or toward the center of the coalescing separator insert.

A main separator 10 of the coalescing separator insert 100 acting according to the coalescence principle is arranged around an air-permeable cylindrical supporting support tube 12, for example, wound in multiple layers around the support tube 12.

The main separator 10 may be, for example, of glass fiber paper and comprise a significant proportion of micro glass fibers. For example, the main separator 10 may comprise 5 to 20, for example, 15, individual layers. Each individual one of these layers may comprise, for example,
a weight of approximately 60 to 200 grams per square meter (g/m²) and/or
an air permeability of 5 l/m²s to 300 l/m²s, for example, determined according to DIN EN ISO 9237, at a pressure of 200 Pascal [Pa], and/or,
a thickness of approximately 0.4 mm to 1 mm, for example, measured at a pressure of 10 kPa in accordance with ISO 543.

A further coalescing separator body 20 acting according to the coalescence principle, namely a post separator, is arranged radially inside (compare FIGS. 1 to 6) or radially outside (compare FIGS. 7 and 8) of a first coalescing separator body 10, namely of a main separator 10. This post separator 20 is arranged concentrically or coaxially to the main separator 10 and may be spaced apart by a drainage chamber 30 from the main separator 10. In addition to the function of draining the separated drops through the outlet for the separated oil 230, the drainage chamber 30 has the function of preventing that the coalescing separator media of the main separator 10 and of the post separator 20 will catch on each other when assembling the coalescing separator insert.

So that the post separator 20 withstands the pressure of the air flowing through, it is wound around a further supporting support tube 22. The winding is embodied of multiple layers and is held together by local fixation regions 26, for example by fused spots.

The fixation regions 26 are distributed across the length of the post separator 20, for example along the longitudinal axis L of the post separator, as well as arranged at an axial spacing relative to each other, respectively.

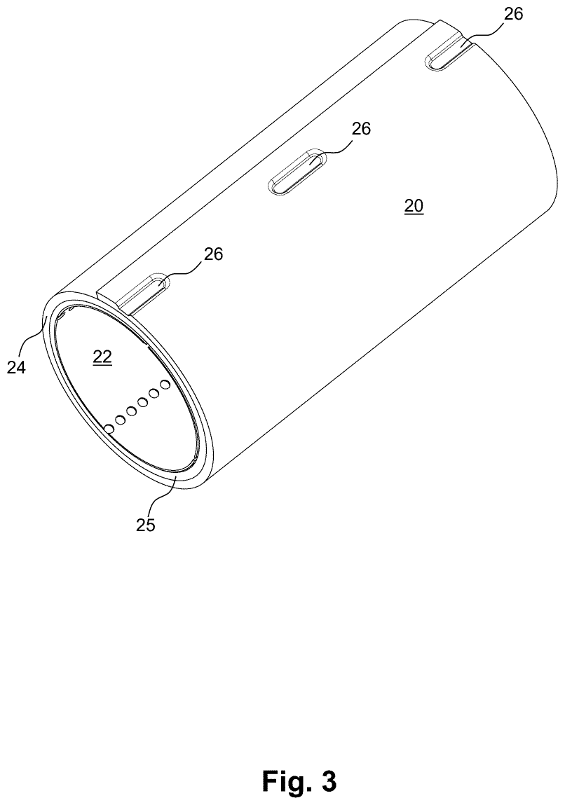

FIGS. 3 to 6 show the post separator 20, wherein the local fused fixation regions 26 as well as the individual layers 24, 25 of the post separator 20 are illustrated.

The post separator layers 24, 25 and the layer of the main separator 10 are illustrated in FIG. 2 in a serial arrangement in which the air flow extends from the exterior to the interior. As an alternative, the air flow may however also extend from the interior to the exterior in the present invention, wherein the post separator layers 24, 25 would then be lying radially farther from the longitudinal axis L of the coalescing separator insert 100 than the main separator 10.

The post separator layers 24, 25 are thus always located downstream of the main separator 10. This means that, for a gas flow guided from the exterior to the interior, the post separator layers 24, 25 are closer to the longitudinal axis L of the coalescing separator insert 100; 102 and, in case of a gas flow guided from the interior to the exterior, the main separator 10 is closer to the longitudinal axis L of the coalescing separator insert 100.

The post separator 20 may comprise the following features, for example:
constructed from nonwoven, for example, staple fiber nonwoven, spunbond, or meltblown;
constructed from the materials polyester, polyamide, glass or mixtures thereof;
the air permeability of the entire post separator, for example, determined according to DIN EN ISO 9237, may be substantially higher, for example by the factor two, than the air permeability of the individual coalescing layers of the main separator 10;
the thickness of the entire post separator 20, for example, determined according to DIN EN ISO 9073-2, may amount to at least 3 mm;
the thickness of the entire post separator 20 may be smaller than the thickness of the main separator 10; and
the air permeability of the entire post separator 20, for example, determined according to DIN EN ISO 9237, may amount to between 300 l/m²s and 4,500 l/m²s at 200 Pa.

The multilayer arrangement of the post separator 20 provides the following advantages:
the degree of separation of the post separator is significantly increased;
the drainage properties are not negatively affected which may be the case, for example, when using a single-layer post separator with a higher degree of separation;
the as a whole greater thickness of the post separator increases drainage of the coalescing drops which is advantageous for larger coalescing separators; and,
in comparison to the use of an individually adapted single-layer coalescing separator body, the multi-layer arrangement of a conventional coalescing separator medium material is economically better and permits in addition the individual adaptation of the post separator with respect to its degree of separation.

The further embodiment illustrated in FIGS. 7 and 8 of a coalescing separator insert 102 differs from the coalescing separator insert 100 illustrated in FIGS. 1 to 6 in the flow direction of the gas flow. In the coalescing separator insert 102 illustrated in FIGS. 7 and 8, the gas flow flows in the position of use from the interior to the exterior through the coalescing separator insert 102.

### REFERENCE CHARACTERS

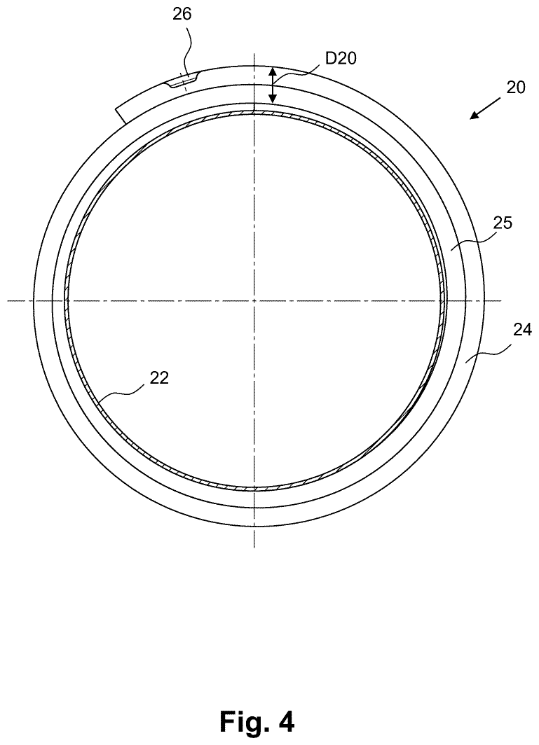

10 first coalescing separator body for separation of liquid (drops) from a gas flow, for example, of oil (drops) from a (compressed) air flow, for example main separator medium body or main separator body, comprising the first coalescing separator medium in operative, optionally tailored, stacked, wound, folded etc., form
12 first support tube, for example main separator support tube, for example, first central tube configured to support the first coalescing separator body 10
20 further coalescing separator body, for example post separator medium body or post separator body, comprising the further coalescing separator medium in operative, optionally tailored, stacked, wound, folded etc., form
22 further support tube, for example post separator support tube, for example, further central tube for supporting the further coalescing separator body 20
24 first coalescing separator medium layer of the further coalescing separator body 20, for example first layer of the post separator 20
25 further coalescing separator medium layer of the further coalescing separator body 20, for example further layer of the post separator 20
26 fixation region of the further coalescing separator body 20, for example connection region, for example, region connected by means of the technique of fusing and/or gluing and/or sewing,
30 drainage chamber arranged between first coalescing separator body 10 and the further coalescing separator body 20 for discharging oil separated by means of the first coalescing separator body 10
50 end disk, facing the cover 212, of the coalescing separator insert 100, 102 of the coalescing separator 200 (first embodiment, see FIG. 1)
50′ end disk, facing the cover 212, of the coalescing separator insert 100 of the coalescing separator 202 (second embodiment, see FIG. 2)
52 end disk, facing away from the cover 212, of the coalescing separator insert 100, 102 of the coalescing separator 200 (first embodiment, see FIG. 1)
52′ end disk, facing away from the cover 212, of the coalescing separator insert 100 of the coalescing separator 202 (second embodiment, see FIG. 2)
54′ flange of the end disk 50′ of the coalescing separator insert 100
100 coalescing separator insert, first embodiment; compare FIGS. 1 to 6
102 coalescing separator insert, further embodiment; compare FIGS. 7 and 8
200 coalescing separator, for example spin-on air oil separator, first embodiment, see FIG. 1;
202 coalescing separator, second embodiment, see FIG. 2
210 housing body of a pressure-stable housing of the coalescing separator 200
212 cover of the pressure-stable housing of the coalescing separator 200
220 raw gas inlet of the coalescing separator 200
230 outlet for the separated liquid, for example, for separated oil
240 clean gas outlet of the coalescing separator 200
242 clean gas outlet of the connector element, for example nipple
320 raw gas feed of the connector element
330 clean gas discharger of the connector element
D20 radial thickness of the further coalescing separator body 20 (compare FIG. 4)
L longitudinal axis of the further coalescing separator body 20 or central axis of the housing body 210

That which is claimed is:

1. A coalescing separator insert for separating liquid from a gas flow that flows through the coalescing separator insert in a flow direction from an exterior to an interior of the coalescing separator insert or from the interior to the exterior of the coalescing separator insert, the coalescing separator insert comprising:
at least one first coalescing separator body comprising at least one first coalescing separator medium configured to separate liquid from the gas flow by coalescence;
an air-permeable, cylindrical first support tube configured to support the at least one first coalescing separator body, wherein the at least one first coalescing separator medium is arranged around the air-permeable, cylindrical first support tube;
at least one second coalescing separator body comprising at least one second coalescing separator medium configured to separate liquid from the gas flow by coalescence, wherein the at least one second coalescing separator medium is arranged downstream of the at least one first coalescing separator body in the flow direction of the gas flow and is arranged concentrically to the at least one first coalescing separator body;
wherein the at least one second coalescing separator medium is wound, at least in sections, into a multi-layer winding;
wherein the at least one second coalescing separator body comprises, at least in sections, at least two layers of the at least one second coalescing separator medium arranged overlappingly relative to each other in the flow direction of the gas flow;
wherein the at least two layers of the at least one second coalescing separator medium arranged overlappingly relative to each other are connected to each other at least in sections for fixation of the multi-layer winding.

2. The coalescing separator insert according to claim 1, further comprising a second support tube configured to support the at least one second coalescing separator body, wherein the at least one second coalescing separator medium is wound around the second support tube.

3. The coalescing separator insert according to claim 1, wherein the at least two layers of the at least one second coalescing separator medium arranged overlappingly relative to each other are connected to each other by one or more joining techniques to form at least two fixation regions, wherein the one or more joining techniques are selected from the group consisting of fusing, gluing, and sewing, wherein the at least two fixation regions are spaced apart from each other in a direction of a longitudinal axis of the at least one second coalescing separator body.

4. The coalescing separator insert according to claim 3, wherein the at least two fixation regions and unconnected overlapping regions of the at least two layers of the at least one second coalescing separator medium arranged overlappingly relative to each other are alternatingly arranged in the direction of the longitudinal axis of the at least one second coalescing separator body and form an interrupted seam extending in the direction of the longitudinal axis of the at least one second coalescing separator body.

5. The coalescing separator insert according to claim 1, wherein the at least one second coalescing separator medium comprises a grammage of up to 300 grams per square meter (g/m²).

6. The coalescing separator insert according to claim 1, wherein a material of the at least one second coalescing separator medium comprises one or more fibers selected from the group consisting of polyester fibers, polyamide fibers, and glass fibers.

7. The coalescing separator insert according to claim 1, wherein a radial thickness of the at least one second coalescing separator body is less than a radial thickness of the at least one first coalescing separator body.

8. The coalescing separator insert according to claim 1, wherein an overlap of a radially outer layer of the at least two layers of the at least one second coalescing separator medium arranged overlappingly relative to each other amounts to at least one sixteenth of a full turn winding of the multi-layer winding.

9. The coalescing separator insert according to claim 1, wherein the at least one second coalescing separator body is configured such that, at a pressure of 200 Pascal, a gas flow permeability of the gas flow through the at least one second coalescing separator body amounts to more than 300 liters per square meter second (l/m²s) and less than 4,500 liters per square meter second (l/m²s).

10. The coalescing separator insert according to claim 1, wherein the at least one second coalescing separator body comprises a gas flow permeability of the gas flow higher than a gas flow permeability of a layer of the at least one first coalescing separator medium.

11. A coalescing separator comprising:
a coalescing separator insert according to claim 1;
a pressure-stable housing configured to receive the coalescing separator insert;
wherein the pressure-stable housing comprises: a cup-shaped housing body; a cover configured to close an open end face of the cup-shaped housing body;
a raw gas inlet configured to supply raw gas to the coalescing separator; and a clean gas outlet configured to discharge a clean gas.

12. The coalescing separator according to claim 11, wherein the raw gas inlet and the clean gas outlet are arranged at the cover, wherein the clean gas outlet comprises a central cylinder-shaped cutout configured to receive a tubular nipple of a connector element of a machine, wherein the tubular nipple extends axially through the cover, and wherein the cover comprises at least one closure element configured to move by a rotational movement of the cover between an open position, configured to guide the tubular nipple along a central axis of the cup-shaped housing body through the cover, and a closed position, wherein the tubular nipple is fixedly connected to the cover in the closed position.

13. The coalescing separator according to claim 11, wherein the raw gas inlet is arranged at the cup-shaped housing body and the clean gas outlet is arranged at the cover, and wherein the coalescing separator insert is hollow cylindrical and comprises end faces each covered by an end disk, wherein the end disk which is facing the cover comprises a radially extending flange configured to arrange the coalescing separator insert in the pressure-stable housing.

14. A method of manufacturing a coalescing separator insert configured to clean a gas flow that flows through the coalescing separator insert from an exterior to an interior of the coalescing separator insert or from the interior to the exterior of the coalescing separator insert, the method comprising:
arranging at least one first coalescing separator medium, configured to separate a liquid from the gas flow by coalescence, around an air-permeable, cylindrical first support tube, configured to support the at least one first coalescing separator medium, to provide a first coalescing separator body;
winding at least one second coalescing separator medium, configured to separate the liquid from the gas flow by coalescence, concentrically to the first coalescing separator body to provide a second coalescing separator body and winding the at least one second coalescing separator medium to a multi-layer winding such that the second coalescing separator body comprises, at least in sections, at least two layers of the at least one second coalescing separator medium arranged overlappingly relative to each other in a flow direction of the gas flow; and
for stabilizing the multi-layer winding of the second coalescing separator body, connecting to each other at least regions of the at least two layers of the at least one second coalescing separator medium arranged overlappingly relative to each other.

15. The method according to claim 14, further comprising winding the at least one second coalescing separator medium around an air-permeable, cylindrical second support tube configured to support the at least one second coalescing separator medium.

16. The method according to claim 14, wherein the regions are distributed across a length the second coalescing separator body and are arranged at an axial spacing relative to each other, respectively.

17. A method of separating oil from air of a compressed air system or of a vacuum system or from gases of a crankcase of an internal combustion engine, the method comprising using a coalescing separator insert, wherein the coalescing separator insert is a coalescing separator insert according to claim 1.

18. The method according to claim 17, further comprising returning the oil separated from the air to a connector element of the compressed air system or to a connector element of the vacuum system.

19. A method of separating oil from air of a compressed air system or of a vacuum system or from gases of a crankcase of an internal combustion engine, the method comprising using a coalescing separator, wherein the coalescing separator is a coalescing separator according to claim 11.

20. The method according to claim 19, further comprising returning the oil separated from the air to a connector element of the compressed air system or to a connector element of the vacuum system.
